(19) United States
(12) Patent Application Publication
(10) Pub. No.: US 2021/0344706 A1
(43) Pub. Date: Nov. 4, 2021

(54) METHOD AND APPARATUS FOR IMPLEMENTING SERVER ANTI-ATTACK

(71) Applicant: WANGSU SCIENCE & TECHNOLOGY CO., LTD., Shanghai (CN)

(72) Inventors: Xiaochuan ZHUANG, Shanghai (CN); Maolin LIU, Shanghai (CN); Zhiming ZHANG, Shanghai (CN)

(21) Appl. No.: 16/473,095

(22) PCT Filed: Sep. 28, 2018
(86) PCT No.: PCT/CN2018/108243

§ 371 Date: Jun. 24, 2019

(30) Foreign Application Priority Data
Aug. 22, 2018 (CN) 201810963244.8

(51) Int. Cl. H04L 29/06

(52) U.S. Cl. CPC H04L 63/1458; H04L 63/1416; H04L 63/20; H04L 63/0236; H04L 63/1425

(57) ABSTRACT

A method for implementing a server anti-attack includes that: after receiving a first link request, the server may determine a target request type of the first link request based on feature information of the first link request; determine, based on the target request type of the first link request, a number of requests that are initiated by a source IP address within a first preset period and have a request type consistent with the target request type; and, in the condition that the number of requests is greater than a preset threshold, determine a target attack type of the first link request, reject the first link request, and add the source IP address to the first collection.

### FIELD OF DISCLOSURE

The present disclosure generally relates to the field of computer technology and, more particularly, relates to a method and apparatus for implementing a server anti-attack.

### BACKGROUND

With the development of the Internet, a variety of network platforms emerge one after another. For these network platforms, there are more and more malicious network attacks. Taking a live streaming service platform as an example, a majority of live streaming providers select a CDN system for accelerating the live streaming. Since the IP address of a server in a CDN system is visible to the outside, the server easily gets attacked by a hacker. For example, a hacker may launch a large-scale SYN attack or URL attack against a server, which likely causes the server to be overloaded, and thus affects the service quality on a node(s).

In a conventional CDN system, a server may perform, at a kernel layer, certain protection against an SYN flood attack towards TCP. However, this kind of protection may only be used against a general SYN attack initiated by a virtual IP address, but may not prevent an attack initiated by a real IP address.

In light of the above, there is a need for a method for implementing a server anti-attack, to solve the problem in the existing technologies that an attack initiated by a real IP address cannot be prevented.

### BRIEF SUMMARY OF THE DISCLOSURE

The embodiments of the present disclosure provide a method and apparatus for implementing a server anti-attack, to solve the problem in the existing technologies that an attack initiated by a real IP address cannot be prevented.

The embodiments of the present disclosure provide a method for implementing a server anti-attack. The method includes:

receiving, by a server, a first link request, where the first link request includes a source IP address that initiates the first link request;

determining, by the server, a target request type of the first link request based on feature information of the first link request, where the feature information of the first link request includes at least one of request data, a requesting rule, and requested content;

determining, by the server, the number of requests that are initiated by the source IP address within a first preset period and have a request type consistent with the target request type based on the target request type of the first link request; and

if it is determined that the number of requests, that are initiated by the source IP address and have a request type consistent with the target request type, is greater than a preset threshold, determining, by the server, a target attack type of the first link request based on the target request type, rejecting the first link request, and adding the source IP address to a first collection, where the first collection is configured to store IP addresses that the server denies access.

In this way, based on the different request types, the server may adopt different anti-attack strategies to achieve the objective of server anti-attack, which may effectively improve the anti-attack capability of the entire server, and effectively reduce the risk caused by the server attack, thereby improving the service quality of the server, ensuring the consistency and stability of the services provided by the server, and enhancing the user experience of Internet access.

In one possible implementation, determining, by the server, the target request type of the first link request based on the feature information of the first link request includes:

if it is determined, based on the request data of the first link request, that the request data cannot be assembled into a request format that can be recognized by the server, determining, by the server, that the target request type of the first link request is an SYN flood request;

determining, by the server, the number of requests that are initiated by the source IP address within the first preset period and have a request type consistent with the target request type includes:

determining, by the server, the number of requests that are initiated by the source IP address within the first preset period and have a request type of an SYN flood request; and

if it is determined that the number of requests, that are initiated by the source IP address and have a request type consistent with the target request type, is greater than the preset threshold, determining, by the server, the target attack type of the first link request based on the target request type includes:

if it is determined that the number of SYN flood requests initiated by the source IP address is greater than a first preset threshold, determining, by the server, that the target attack type of the first link request is an SYN flood attack.

In one possible implementation, determining, by the server, the target request type of the first link request based on the feature information of the first link request includes:

if it is determined, based on the request data and the requesting rule of the first link request, that the request data can be assembled into a request format that can be recognized by the server but the requesting rule does not satisfy a preset rule, determining, by the server, that the target request type of the first link request is an illegal URL request;

determining, by the server, the number of requests that are initiated by the source IP address within the first preset period and have a request type consistent with the target request type includes:

determining, by the server, the number of requests that are initiated by the source IP address within the first preset period and have a request type of an illegal URL request; and

if it is determined that the number of requests, that are initiated by the source IP address and have a request type consistent with the target request type, is greater than the preset threshold, determining, by the server, the target attack type of the first link request based on the target request type includes:

if it is determined that the number of illegal URL requests initiated by the source IP address is greater than a second preset threshold, determining, by the server, that the target attack type of the first link request is an illegal URL attack.

In one possible implementation, determining, by the server, the target request type of the first link request based on the feature information of the first link request includes:

if it is determined, based on the request data and the requesting rule of the first link request, that the request data can be assembled into a request format that can be recognized by the server and the requesting rule satisfies a preset rule, determining, by the server, that the target request type of the first link request is a candidate legal URL request, and

if it is determined, based on the requested content of the first link request, that the requested content is inconsistent with content of services provided by the server, determining, by the server, that the candidate legal URL request is a first type of legal URL request;

determining, by the server, the number of requests that are initiated by the source IP address within the first preset period and have a request type consistent with the target request type includes:

determining, by the server, the number of requests that are initiated by the source IP address within the first preset period and have a request type of a first type of legal URL request; and

if it is determined that the number of requests, that are initiated by the source IP address and have a request type consistent with the target request type, is greater than the preset threshold, determining, by the server, the target attack type of the first link request based on the target request type includes:

if it is determined that the number of first type of legal URL requests is greater than a third preset threshold, determining, by the server, that the target attack type of the first link request is a legal URL attack.

In one possible implementation, the method further includes:

if it is determined that the requested content is consistent with the content of services provided by the server, determining, by the server, that the candidate legal URL request is a second type of legal URL request;

if it is determined that the source IP address is included in a second collection, determining, by the server, the number of second type of legal URL requests initiated by the source IP address within a second preset period, where the second collection is configured to store IP addresses restricted by the server and corresponding numbers of requests received after restrictions; and

if it is determined that the number of second type of legal URL requests initiated by the source IP address within the second preset period is greater than the number of requests received after a restriction, determining, by the server, that the target attack type of the first link request is a legal URL attack, rejecting the first link request, and adding the source IP address to the first collection.

In one possible implementation, the method further includes:

if it is determined that the number of second type of legal URL requests initiated by the source IP address within the second preset period is less than or equal to the number of requests received after the restriction, determining, by the server, that the first link request is a legal request.

In one possible implementation, the method further includes:

if it is determined that the source IP address is not included in the second collection, determining, by the server, the number of second type of legal URL requests initiated by the source IP address within a third preset period;

if it is determined that the number of second type of legal URL requests initiated by the source IP address within the third preset period is greater than a fourth preset threshold, restricting, by the server, the number of requests from the source IP address and adding the source IP address to the second collection, where the third preset period is earlier than the second preset period; and

if it is determined that the number of second type of legal URL requests initiated by the source IP address within the third preset period is less than or equal to the fourth preset threshold, determining, by the server, that the first link request is a legal request.

In one possible implementation, after receiving the first link request and before determining the target request type of the first link request, the method further includes:

determining, by the server, that the source IP address is not included in the first collection.

The embodiments of the present disclosure provide an apparatus for implementing a server anti-attack. The apparatus includes:

a receiving unit that is configured to receive a first link request, where the first link request includes a source IP address that initiates the first link request; and

a processing unit that is configured to determine a target request type of the first link request based on feature information of the first link request, where the feature information of the first link request includes at least one of request data, a requesting rule, and requested content; determine the number of requests that are initiated by the source IP address within a first preset period and have a request type consistent with the target request type based on the target request type of the first link request; and if it is determined that the number of requests, that are initiated by the source IP address and have a request type consistent with the target request type, is greater than a preset threshold, determine a target attack type of the first link request based on the target request type, reject the first link request, and add the source IP address to a first collection, where the first collection is configured to store IP addresses that the server denies access.

In one possible implementation, the processing unit is specifically configured to:

if it is determined, based on the request data of the first link request, that the request data cannot be assembled into a request format that can be recognized by the server, determine that the target request type of the first link request is an SYN flood request; determine the number of requests that are initiated by the source IP address within the first preset period and have a request type of a SYN flood request; and if it is determined that the number of SYN flood requests initiated by the source IP address is greater than a first preset threshold, determine that the target attack type of the first link request is an SYN flood attack.

In one possible implementation, the processing unit is specifically configured to:

if it is determined, based on the request data and the requesting rule of the first link request, that the request data can be assembled into a request format that can be recognized by the server but the requesting rule does not satisfy a preset rule, determine that the target request type of the first link request is an illegal URL request; determine the number of requests that are initiated by the source IP address within the first preset period and have a request type of an illegal URL request; and if it is determined that the number of illegal URL requests initiated by the source IP address is greater than a second preset threshold, determine that the target attack type of the first link request is an illegal URL attack.

In one possible implementation, the processing unit is specifically configured to:

if it is determined, based on the request data and the requesting rule of the first link request, that the request data can be assembled into a request format that can be recognized by the server and the requesting rule satisfies a preset rule, determine that the target request type of the first link request is a candidate legal URL request; if it is determined, based on the requested content of the first link request, that the requested content is inconsistent with content of services provided by the server, determine that the candidate legal URL request is a first type of legal URL request; determine the number of requests that are initiated by the source IP address within the first preset period and that have a request type of a first type of legal URL request; and if it is determined that the number of first type of legal URL requests initiated by the source address is greater than a third preset threshold, determine that the target attack type of the first link request is a legal URL attack.

In one possible implementation, the processing unit is further configured to:

if it is determined that the requested content is consistent with the content of services provided by the server, determine that the candidate legal URL request is a second type of legal URL request; if it is determined that the source IP address is included in a second collection, determine the number of second type of legal URL requests initiated by the source IP address within a second preset period, where the second collection is to store IP addresses restricted by the server and corresponding numbers of requests after restrictions; and if it is determined that the number of second type of legal URL requests initiated by the source IP address within the second preset period is greater than the number of requests received after a restriction, determine that the target attack type of the first link request is a legal URL attack, reject the first link request, and add the source IP address to the first collection.

In one possible implementation, the processing unit is further configured to:

if it is determined that the number of second type of legal URL requests initiated by the source IP address within the second preset period is less than or equal to the number of requests received after the restriction, determine that the first link request is a legal request.

In one possible implementation, the processing unit is further configured to:

if it is determined that the source IP address is not included in the second collection, determine the number of second type of legal URL requests initiated by the source IP address within a third preset period; if it is determined that the number of second type of legal URL requests initiated by the source IP address within the third preset period is greater than a fourth preset threshold, restrict the number of requests from the source IP address and add the source IP address to the second collection, where the third preset period is earlier than the second preset period; and if it is determined that the number of second type of legal URL requests initiated by the source IP address within the third preset period is less than or equal to the fourth preset threshold, determine that the first link request is a legal request.

In one possible implementation, after receiving the first link request and before determining the target request type of the first link request, the processing unit is further configured to:

determine that the source IP address is not included in the first collection.

The embodiments of the present disclosure further provide an apparatus. The apparatus includes the functionality of implementing the above-described methods for implementing a server anti-attack. The functionality may take the form of implementation of hardware executing corresponding software. In one possible design, the apparatus includes a processor, a transceiver, and a memory. The memory is configured to store instructions executed by a computer. The transceiver is configured to enable the communication of the apparatus with other communication entities. The processor connects with the memory via a bus. When the apparatus is running, the processor executes the computer-executable instructions stored by the memory, to cause the apparatus to implement the methods for implementing a server anti-attack described above.

The embodiments of the present disclosure further provide a computer-readable storage medium. The computer-readable storage medium stores software programs that, when read and executed by one or more processors, implement the methods for implementing a server anti-attack described in the above various possible implementations.

The embodiments of the present disclosure further provide a computer program product comprising instructions that, when executed on a computer, cause the computer to implement the methods for implementing a server anti-attack described in the above various possible implementations.

### BRIEF DESCRIPTION OF THE DRAWINGS

To make the technical solutions in the embodiments of the present disclosure clearer, a brief introduction of the accompanying drawings consistent with the description of the embodiments will be provided hereinafter.

FIG. 1 is a schematic diagram of a network architecture according to some embodiments of the present disclosure;

FIG. 2 is a flowchart of a method for implementing a server anti-attack according to some embodiments of the present disclosure;

FIG. 3 is a flowchart of a method for determining a target request type according to some embodiments of the present disclosure;

FIG. 4 is a schematic diagram of an overall process according to some embodiments of the present disclosure; and

FIG. 5 is a schematic structural diagram of an apparatus for implementing a server anti-attack according to some embodiments of the present disclosure.

### DETAILED DESCRIPTION

The present disclosure will be made in details hereinafter with reference to the accompanying drawings of the specification. The specific operations in the method-related embodiments may also be applicable to the apparatus-related embodiments.

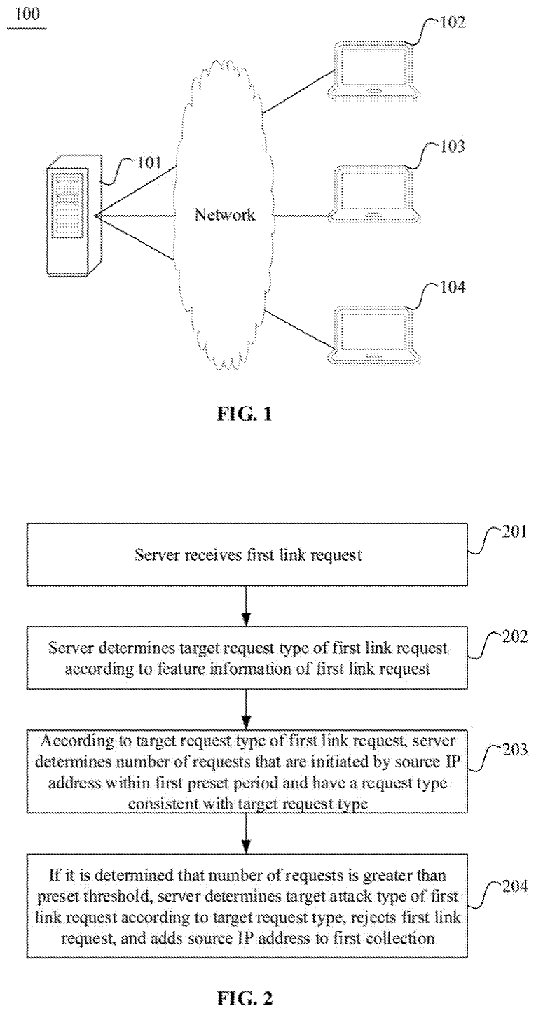

FIG. 1 exemplarily shows a schematic diagram of a system architecture according to some embodiments of the present disclosure. As shown in FIG. 1, the system 100 includes a server 101 and at least one client device, for example, the client device 102, the client device 103, and the client device 104 shown in the figure. The server 101 may communicate with the client device 102, the client device 103, and the client device 104 through a network. For example, any of the client device 102, the client device 103, and the client device 104 may send a link request to the server 101. The server 101 may provide access to the client device based on the link request and return a response message to the client device.

In the embodiments of the present disclosure, the server may include a large variety of types of servers, such as an edge server in a CDN system. Further, for a CDN system, different edge servers may parse different domain name requests. Accordingly, the server in the embodiments of the present disclosure may be an edge server for parsing live streaming service, or an edge server for parsing search service, or an edge server for parsing video service, which is not limited by the present disclosure.

Further, the client devices may include a large variety of types of devices, such as a notebook, a smartphone, a tablet, a smart TV, etc.

Based on the system architecture shown in FIG. 1, FIG. 2 exemplarily shows a flowchart of a method for implementing a server anti-attack according to some embodiments of the present disclosure. As shown in FIG. 2, the method includes the following specific steps:

Step 201: The server receives a first link request.

Step 202: The server determines a target request type of the first link request based on feature information of the first link request.

Step 203: According to the target request type of the first link request, the server determines the number of requests that are initiated by the source IP address within a first preset period and have a request type consistent with the target request type.

Step 204: If it is determined that the number of requests, that are initiated by the source IP address and have a request type consistent with the target request type, is greater than a preset threshold, the server determines the target attack type of the first link request based on the target request type, rejects the first link request, and adds the source IP address to a first collection.

It should be noted that the above Step 202 to Step 204 may be implemented using an auto-learn algorithm, details of which will be provided later.

In this way, the server may adopt different anti-attack strategies according to different request types, to achieve the objective of server anti-attack. This may effectively improve the anti-attack capability of the entire server and effectively reduce the risk caused by the server attack, thereby improving the service quality of the server, ensuring the consistency and stability of the services provided by the server, and enhancing the user experience of Internet access.

Specifically, in Step 201, the first link request may be a link request for a URL. That is, the first link request may be in the form: protocol name://host.domain name/path/filename. Further, the first link request may include a source IP address that initiates the request. Taking the system architecture shown in FIG. 1 as an example, the client device 102 may send a first link request to the server 101, where the first link request sent by the client device 102 may include the IP address of the client device 102.

Before performing Step 202, the server may first determine whether the source IP address is included in a first collection of IP addresses. If the source IP address is not in the first collection, Step 202 may be performed. If the source IP address is already in the first collection, the server may reject the first link request. Here, the first collection may be configured to store IP addresses that were denied access by the server.

In Step 202, the feature information of the first link request may include a large variety of content. For example, the feature information of the first link request may include request data, or a requesting rule, or requested content. Alternatively, the feature information of the first link request may further include the request data and the requesting rule, or the request data and the requested content, or the requesting rule and the requested content. Alternatively, the feature information of the first link request may further include the request data, the requesting rule, and the requested content. The specific feature information of the first link request is not limited by the present disclosure.

Further, since there are a variety of approaches to initiating a request towards the server, determining a request type may allow the adoption of the corresponding anti-attack strategy more specifically, to improve the anti-attack capability of the server. In view of this, the server may determine a target request type of the first link request based on the feature information of the first link request.

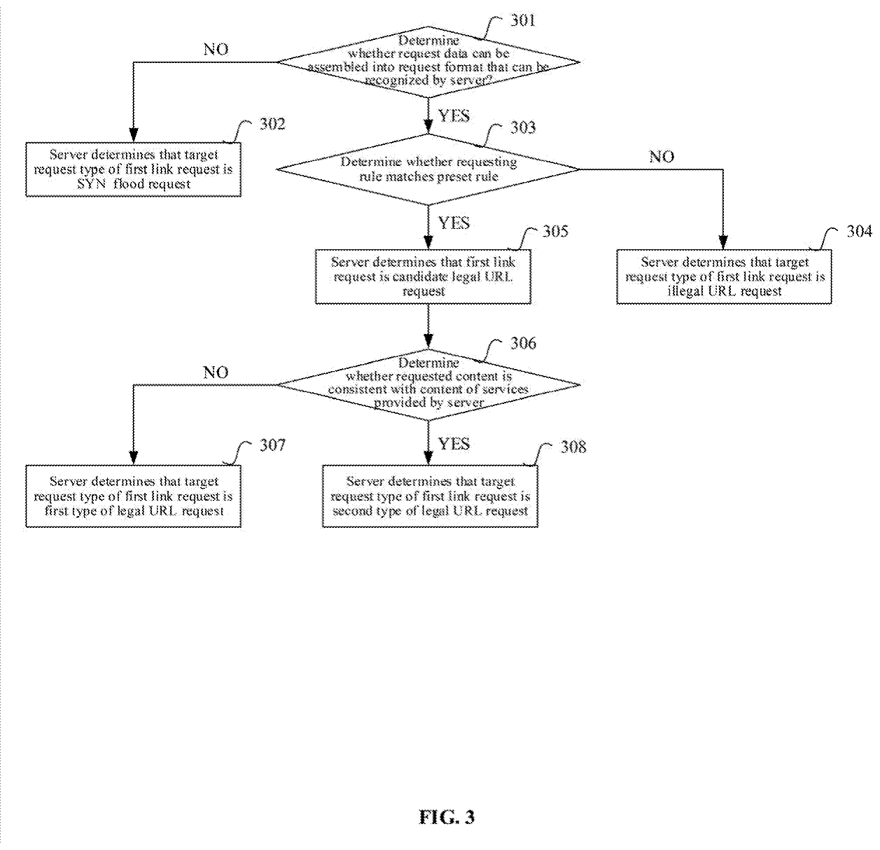

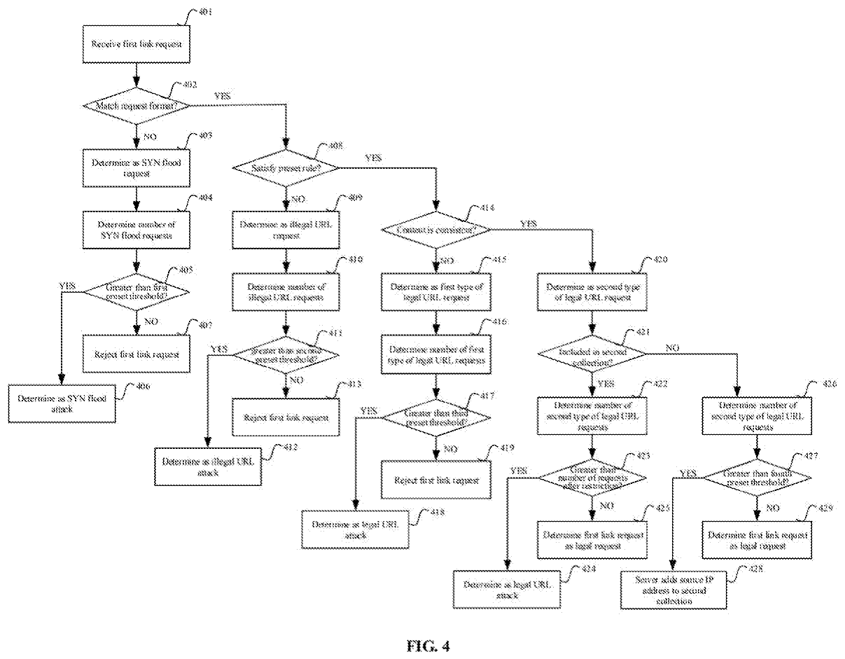

Specifically, the feature information of the first link request includes the request data, the requesting rule, and the requested content. FIG. 3 exemplarily shows a flowchart of a method for determining a target request type according to some embodiments of the present disclosure. As shown in FIG. 3, the method includes the following specific steps.

Step 301: The server determines, according to the request data of the first link request, whether the request data of the first link request can be assembled into a request format that can be recognized by the server. If the request data cannot be assembled into a request format that can be recognized by the server, proceed to Step 302. If the request data can be assembled into a request format that can be recognized by the server, proceed to Step 303.

In the embodiments of the present disclosure, consider that the services parsed by different servers are different. For example, if the server is configured to parse the live streaming service, it may be determined whether the request data of the first link request can be assembled into a request format that can be recognized by a server responsible for parsing the live streaming service. For another example, if the server is configured to parse the search service, it may be determined whether the request data of the first link request can be assembled into a request format that can be recognized by a server responsible for parsing the search service.

Further, a request format that can be recognized by the server may include an HTTP URL format that can be recognized by the server or an RTMP format that can be recognized by the server.

In one example, an auto-learn algorithm is used to implement the foregoing Step 301. If the first link request is a request in an HTTP URL format, since a standard HTTP request header generally consists of a request mode, a request URL, a request protocol, and a request header, which is ended with \r\n\r\n, the auto-learn algorithm may determine whether the request data of the first link request can be assembled into a complete HTTP header within a preset time period, and determine whether the first link request conforms to a standard HTTP protocol. If the request data can be assembled into a complete HTTP header and also conforms to the standard HTTP protocol, it is determined that the request data of the first link request can be assembled into an HTTP URL format that can be recognized by the server. If the request data cannot be assembled into a complete HTTP header or does not conform to a standard HTTP protocol, it is determined that the request data of the link request cannot be assembled into an HTTP URL format that can be recognized by the server.

If the first link request is a request in an RTMP format, since a standard RTMP request includes a first byte of 03 followed by 1536 bytes of request data, the auto-learn algorithm may determine whether a data amount of 1536 bytes is received within a preset time period after receiving the first byte. If the data amount of 1536 bytes is received within the preset time period, it is determined that the request data of the first link request can be assembled into an RTMP format that can be recognized by the server. If the data amount of 1536 bytes is not received within the preset time period, it is determined that the request data of the first link request cannot be assembled into an RTMP format that can be recognized by the server.

In the embodiments of the present disclosure, considering a large number of first link requests received by the server, in order to improve the efficiency of the server, the server may make a determination about the request data within a preset time period. If after the preset time period, the server still cannot determine whether the request data can be assembled into a request format that can be recognized by the server, it is considered that the request data cannot be assembled into a request format that can be recognized by the server.

Step 302: The server determines that the target request type of the first link request is an SYN flood request.

In the embodiments of the present disclosure, the characteristics of an SYN flood request is that the source IP address that initiates the request is reachable. If an SYN flood request is not taken care of correspondingly, the source IP address may transmit a large amount of garbage data to the server by initiating a flood attack, which consumes the network card resources of the server, thereby affecting the transmission of normal services.

Step 303: The server determines whether the requesting rule of the first link request satisfies a preset rule. If the requesting rule does not satisfy the preset rule, proceed to Step 304. If the requesting rule satisfies the preset rule, proceed to Step 305.

A preset rule may include various types of rules, such as a request domain name rule, refer rule, user-agent rule, request parameter rule, request policy rule (such as a timestamp anti-theft chain rule), etc., specific details of which are not limited by the present disclosure.

Further, in the case that the preset rule includes various types of rules, there are multiple ways for the server to determine whether the requesting rule of the first link request satisfies a preset rule. In one example, the server may determine whether the requesting rule of the first link request satisfies any of the above various types of rules. In another example, the server may also determine whether the requesting rule of the first link request is consistent with each of the above various types of rules, thereby improving the accuracy of the server in determining the target request type.

In one example, an auto-learn algorithm is used to implement Step 303. The auto-learn algorithm may be used to determine whether the requesting rule of the first link request satisfies a preset rule. For example, after the first link request is received, according to the preset rule(s), such as the service domain name rule (namely, a group of clients that may be supported by a server) or the request policy rule (namely, an algorithm that can be verified by a server), the auto-learn algorithm may be configured to determine whether the requesting rule of the first link request satisfies a preset rule. Taking that the request policy rule is an MD5 timestamp anti-theft chain rule as an example, after determining that a certain MD5 timestamp anti-theft chain rule is configured within a domain name, the auto-learn algorithm may determine whether a host of the first link request belongs to a collection of domain names served by the server. If the host of the first link request belongs to the collection of domain names served by the server, it is then determined whether the parameters included in the URL of the first link request or the parameter information of the HTTP request header satisfies the MD5 timestamp anti-theft chain rule. If the parameters included in the URL of the first link request or the parameter information of the HTTP request header satisfies the MD5 timestamp anti-theft chain rule, it is determined that the requesting rule of the first link request satisfies the preset rule.

Step 304: The server determines that the target request type of the first link request is an illegal URL request.

Step 305: The server determines that the target request type of the first link request is a candidate legal URL request.

Step 306: The server determines whether the requested content of the first link request is consistent with the content of services provided by the server. If the requested content of the first link request is inconsistent with the content of the services provided by the server, proceed to Step 307. If the requested content of the first link request is consistent with the content of the services provided by the server, proceed to Step 308.

As previously described, the server may include a large variety of types of servers. For example, the server may be a server for parsing the live streaming service. That is, the content of the services provided by the server is the content corresponding to the live streaming service. If the requested content of the first link request is other types of content (such as the content corresponding to the search service), it may be then considered that the requested content of the first link request is inconsistent with the content of the services provided by the server.

Specifically, taking a CDN server as an example, the content provided by the server (i.e., the CDN resources of the whole network) may refer to a collection of the resources owned by the edge servers and the resources owned by the central node server. After the request is determined to be a legal URL request, the auto-learn algorithm may be used to further determine whether the requested content of the legal URL request is a resource owned by the server. If the server does not own the requested content of the legal URL request, it is further determined, by using scheduled queries, whether the whole network owns the resource. If both the server and the whole network do not own the resource, it is determined that the CDN does not own the resource. That is, it may be considered that the requested content is inconsistent with the content of the services provided by the server.

Further, a threshold may be set for the requests requesting the resources, that are not owned by the server, within a time unit. If certain types of requests just query, at a regular interval, whether the CDN owns some resources, this activity is considered as a normal activity. However, if a certain type of requests continuously send a large number of requests, for the non-existing resource(s), within a time unit, these requests are considered as an attack activity.

Step 307: The server determines that the candidate legal URL request is a first type of legal URL request.

Step 308: The server determines that the candidate legal URL request is a second type of legal URL request.

It should be noted that: (1) the foregoing step numbers are merely one exemplary representation of the processing flow. The order/sequence of the steps is not specifically limited in the present disclosure. For example, in the above Step 301 and Step 303, the server may first determine whether the requesting rule of the first link request satisfies a preset rule, and then determine whether the request data of the first link request can be assembled into a request format that can be recognized by the server. (2) the method for determining the target request type provided by Step 301 to Step 308 is merely one example. In other possible examples, if the feature information of the first link request includes the request data, the server may determine whether the target request type of the first link request is an SYN flood request by determining whether the request data of the first link request can be assembled into a request format that can be recognized by the server. Alternatively, if the feature information of the first link request includes the request data and the requesting rule, the server may determine the target request type of the first link request by determining whether the request data of the first link request can be assembled into a request format that can be recognized by the server and determining whether the requested content of the first link request is consistent with the content of the services provided by the server.

In Step 203 and Step 204, for different target request types, different anti-attack strategies may be adopted, in the embodiments of the present disclosure, to improve the anti-attack capability of the server.

In one example, if the target request type is an SYN flood request, the server may determine the number of requests that are initiated by the source IP address within a first preset period and have a request type of an SYN flood request. Further, the server may determine whether the number of SYN flood requests initiated by the source IP address is greater than a first preset threshold. If the number of SYN flood requests initiated by the source IP address is greater than the first preset threshold, it may be determined that the target attack type of the first link request is an SYN flood attack. Accordingly, the first link request is rejected and the source IP address is added to the first collection. If the number of SYN flood requests initiated by the source IP address is less than or equal to the first preset threshold, only the first link request is rejected, but the source IP address is not added to the first collection. Here, the first collection may be configured to store IP addresses that the server denies access. That is, after receiving a second link request later, if the server determines that the IP address of the second link request is in the first collection, the server directly denies the access from this IP address without performing the process following the above Step 201.

It should be noted that the time length of the first preset period and the value of the first preset threshold may be determined by a person skilled in the art based on the experience and actual conditions, details of which are not specified by the present disclosure.

In another example, if the target request type is an illegal URL request, the server may determine the number of requests that are initiated by the source IP address within the first preset period and have a request type of an illegal URL request. Further, the server may determine whether the number of illegal URL requests initiated by the source IP address is greater than a second preset threshold. If the number of illegal URL requests initiated by the source IP address is greater than the second preset threshold, it may be determined that the target attack type of the first link request is an illegal URL attack. Accordingly, the first link request is rejected and the source IP address is added to the first collection. If the number of illegal URL requests initiated by the source IP address is less than or equal to the second preset threshold, only the first link request is rejected, but the source IP address is not added to the first collection.

It should be noted that the value of the second preset threshold may be determined by a person skilled in the art based on the experience and actual conditions, detail of which is not specified by the present disclosure.

In yet another example, if the target request type is a first type of legal URL request, the server may determine the number of requests that are initiated by the source IP address within the first preset period and have a request type of a first type of legal URL request. Further, the server may determine whether the number of first type of legal URL requests initiated by the source IP address is greater than a third preset threshold. If the number of first type of legal URL requests initiated by the source IP address is greater than the third preset threshold, it may be determined that the target attack type of the first link request is a legal URL attack. Accordingly, the first link request is rejected and the source IP address is added to the first collection. If the number of first type of legal URL requests initiated by the source IP address is less than or equal to the third preset threshold, only the first link request is rejected, but the source IP address is not added to the first collection.

It should be noted that the value of the third preset threshold may be determined by a person skilled in the art based on the experience and actual conditions, detail of which is not specified by the present disclosure.

In yet another example, if the target request type is a second type of legal URL request, the server may determine whether the source IP address is included in a second collection. If the source IP address is included in the second collection, the server may determine the number of second type of legal URL requests initiated by the source IP address within a second preset period. Further, the server may determine whether the number of second type of legal URL requests initiated by the source IP address within the second preset period is greater than the number of requests received after restriction. If the number of second type of legal URL requests initiated by the source IP address within the second preset period is greater than the number of requests received after the restriction, it may be determined that the target attack type of the first link request is a legal URL attack. If the number of second type of legal URL requests initiated by the source IP address within the second preset period is less than or equal to the number of requests received after the restriction, it is determined that the first link request is a legal request.

Further, if the source IP address is not included in the second collection, the server may determine the number of second type of legal URL requests initiated by the source IP address within a third preset period. The server then determines whether the number of second type of legal URL requests initiated by the source IP address within the third preset period is greater than a fourth preset threshold. If the number of second type of legal URL requests initiated by the source IP address within the third preset period is greater than the fourth preset threshold, the number of requests from the source IP address is restricted and the source IP address is added to the second collection. If the number of second type of legal URL requests initiated by the source IP address within the third preset period is less than or equal to the fourth preset threshold, the first link request is determined to be a legal request. Here, the second collection may be configured to store IP addresses restricted by the server and corresponding numbers of requests received after the restrictions. The third preset period is earlier than the second preset period.

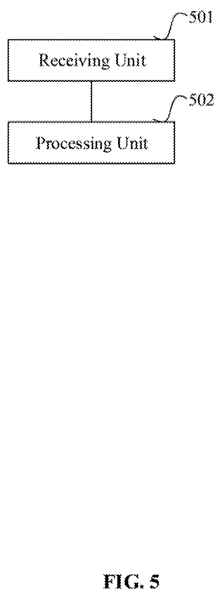

In order to more clearly describe the implementation of the foregoing method for implementing a server anti-attack, the process involved in the embodiments of the present disclosure will be described as a whole hereinafter with reference to FIG. 4. As shown in the figure, the following steps are included:

Step 401: The server receives a first link request.

Step 402: The server determines, according to request data of the first link request, whether the request data of the first link request can be assembled into a request format that can be recognized by the server. If the request data cannot be assembled into a request format that can be recognized by the server, proceed to Step 403. If the request data can be assembled into a request format that can be recognized by the server, proceed to Step 408.

Step 403: The server determines that the target request type of the first link request is an SYN flood request.

Step 404: The server may determine the number of requests that are initiated by the source IP address within a first preset period and have a request type of an SYN flood request.

Step 405: The server may determine whether the number of SYN flood requests is greater than a first preset threshold. If the number of SYN flood requests is greater than the first preset threshold, proceed to Step 406. If the number of SYN flood requests is less than or equal to the first preset threshold, proceed to Step 407.

Step 406: The server determines that the target attack type of the first link request is an SYN flood attack, rejects the first link request, and adds the source IP address to the first collection.

Step 407: The server only rejects the first link request, but does not add the source IP address to the first collection.

Step 408: The server determines whether the requesting rule of the first link request satisfies a preset rule. If the requesting rule does not satisfy a preset rule, proceed to Step 409. If the requesting rule satisfies a preset rule, proceed to Step 414.

Step 409: The server determines that the target request type of the first link request is an illegal URL request.

Step 410: The server may determine the number of requests that are initiated by the source IP address within the first preset period and have a request type of an illegal URL request.

Step 411: The server may determine whether the number of illegal URL requests is greater than a second preset threshold. If the number of illegal URL requests is greater than the second preset threshold, proceed to Step 412. If the number of illegal URL requests is less than or equal to the second preset threshold, proceed to Step 413.

Step 412: The server determines that the target attack type of the first link request is an illegal URL attack, rejects the first link request, and adds the source IP address to the first collection.

Step 413: The server only rejects the first link request, but does not add the source IP address to the first collection.

Step 414: The server determines that the target request type of the first link request is a candidate legal URL request, and determines whether the requested content of the first link request is consistent with the content of services provided by the server. If the requested content of the first link request is inconsistent with the content of the services provided by the server, proceed to Step 415. If the requested content of the first link request is consistent with the content of the services provided by the server, proceed to Step 420.

Step 415: The server determines that the target request type of the first link request is a first type of legal URL request.

Step 416: The server may determine the number of requests that are initiated by the source IP address within the first preset period and have a request type of a first type of legal URL request.

Step 417: The server may determine whether the number of first type of legal URL requests is greater than a third preset threshold. If the number of first type of legal URL requests is greater than the third preset threshold, proceed to Step 418. If the number of first type of legal URL requests is less than or equal to the third preset threshold, proceed to Step 419.

Step 418: The server determines that the target attack type of the first link request is a legal URL attack, rejects the first link request, and adds the source IP address to the first collection.

Step 419: The server only rejects the first link request, but does not add the source IP address to the first collection.

Step 420: The server determines that the target request type of the first link request is a second type of legal URL request.

Step 421: The server determines whether the source IP address is included in the second collection. If the source IP address is included in the second collection, proceed to Step 422. If the source IP address is not included in the second collection, proceed to Step 426.

Step 422: The server determines the number of second type of legal URL requests initiated by the source IP address within the second preset period.

Step 423: The server determines whether the number of second type of legal URL requests initiated by the source IP address within the second preset period is greater than the number of requests received after the restriction. If the number of second type of legal URL requests initiated by the source IP address within the second preset period is greater than the number of requests received after the restriction, proceed to Step 424. If the number of second type of legal URL requests initiated by the source IP address within the second preset period is less than or equal to the number of requests received after the restriction, proceed to Step 425.

Step 424: The server determines that the target attack type of the first link request is a legal URL attack, rejects the first link request, and adds the source IP address to the first collection.

Step 425: The server determines that the first link request is a legal request.

Step 426: The server determines the number of second type of legal URL requests initiated by the source IP address within a third preset period.

Step 427: The server determines whether the number of second type of legal URL requests initiated by the source IP address within the third preset period is greater than a fourth preset threshold. If the number of second type of legal URL requests initiated by the source IP address within the third preset period is greater than the fourth preset threshold, proceed to Step 428. If the number of second type of legal URL requests initiated by the source IP address within the third preset period is less than or equal to the fourth preset threshold, proceed to Step 429.

Step 428: The server restricts the number of requests from the source IP address, and adds the source IP address to the second collection.

Step 429: The server determines that the first link request is a legal request.

Based on the similar inventive concept, FIG. 5 exemplarily shows a schematic structural diagram of an apparatus for implementing a server anti-attack according to the embodiments of the present disclosure. As shown in FIG. 5, the apparatus includes a receiving unit 501 and a processing unit 502, where,

the receiving unit 501 is configured to receive a first link request, where the first link request includes a source IP address that initiates the request; and

the processing unit 502 is configured to determine a target request type of the first link request based on feature information of the first link request, where the feature information of the first link request includes at least one of request data, a requesting rule, and requested content; determine the number of requests that are initiated by the source IP address within a first preset period and have a request type consistent with the target request type based on the target request type of the first link request; and if it is determined that the number of requests, that are initiated by the source IP address and have a request type consistent with the target request type, is greater than a preset threshold, determine a target attack type of the first link request based on the target request type, reject the first link request, and add the source IP address to a first collection, where the first collection is configured to store IP addresses that the server denies access.

In one possible implementation, the processing unit 502 is specifically configured to:

if it is determined, based on the request data of the first link request, that the request data cannot be assembled into a request format that can be recognized by the server, determine that the target request type of the first link request is an SYN flood request; determine the number of requests that are initiated by the source IP address within the first preset period and have a request type of a SYN flood request; and if it is determined that the number of SYN flood requests initiated by the source IP address is greater than a first preset threshold, determine that the target attack type of the first link request is an SYN flood attack.

In one possible implementation, the processing unit 502 is specifically configured to:

if it is determined, based on the request data and the requesting rule of the first link request, that the request data can be assembled into a request format that can be recognized by the server but the requesting rule does not satisfy a preset rule, determine that the target request type of the first link request is an illegal URL request; determine the number of requests that are initiated by the source IP address within the first preset period and have a request type of an illegal URL request; and if it is determined that the number of illegal URL requests initiated by the source IP address is greater than a second preset threshold, determine that the target attack type of the first link request is an illegal URL attack.

In one possible implementation, the processing unit 502 is specifically configured to:

if it is determined, based on the request data and the requesting rule of the first link request, that the request data can be assembled into a request format that can be recognized by the server and the requesting rule satisfies a preset rule, determine that the target request type of the first link request is a candidate legal URL request; if it is determined, based on the requested content of the first link request, that the requested content is inconsistent with content of services provided by the server, determine that the candidate legal URL request is a first type of legal URL request; determine the number of requests that are initiated by the source IP address within the first preset period and that have a request type of a first type of legal URL request; and if it is determined that the number of first type of legal URL requests initiated by the source address is greater than a third preset threshold, determine that the target attack type of the first link request is a legal URL attack.

In one possible implementation, the processing unit 502 is further configured to:

if it is determined that the requested content is consistent with the content of services provided by the server, determine that the candidate legal URL request is a second type of legal URL request; if it is determined that the source IP address is included in a second collection, determine the number of second type of legal URL requests initiated by the source IP address within a second preset period, where the second collection is to store IP addresses restricted by the server and corresponding numbers of requests after restrictions; and if it is determined that the number of second type of legal URL requests initiated by the source IP address within the second preset period is greater than the number of requests received after a restriction, determine that the target attack type of the first link request is a legal URL attack, reject the first link request, and add the source IP address to the first collection.

In one possible implementation, the processing unit 502 is further configured to:

if it is determined that the number of second type of legal URL requests initiated by the source IP address within the second preset period is less than or equal to the number of requests received after the restriction, determine that the first link request is a legal request.

In one possible implementation, the processing unit 502 is further configured to:

if it is determined that the source IP address is not included in the second collection, determine the number of second type of legal URL requests initiated by the source IP address within a third preset period; if it is determined that the number of second type of legal URL requests initiated by the source IP address within the third preset period is greater than a fourth preset threshold, restrict the number of requests from the source IP address and add the source IP address to the second collection, where the third preset period is earlier than the second preset period; and if it is determined that the number of second type of legal URL requests initiated by the source IP address within the third preset period is less than or equal to the fourth preset threshold, determine that the first link request is a legal request.

In one possible implementation, after receiving the first link request and before determining the target request type of the first link request, the processing unit 502 is further configured to:

determine that the source IP address is not included in the first collection.

The embodiments of the present disclosure further provide an apparatus. The apparatus includes the functionality of implementing the above-described methods for implementing a server anti-attack. The functionality may take the form of implementation of hardware executing corresponding software. In one possible design, the apparatus includes a processor, a transceiver, and a memory. The memory is configured to store instructions executed by a computer. The transceiver is configured to enable the communication of the apparatus with other communication entities. The processor connects with the memory via a bus. When the apparatus is running, the processor executes the computer-executable instructions stored by the memory, to cause the apparatus to implement the methods for implementing a server anti-attack described above.

The embodiments of the present disclosure further provide a computer-readable storage medium. The computer-readable storage medium stores software programs that, when read and executed by one or more processors, implement the methods for implementing a server anti-attack described in the above various possible implementations.

The embodiments of the present disclosure further provide a computer program product comprising instructions that, when executed on a computer, cause the computer to implement the methods for implementing a server anti-attack described in the above various possible implementations.

Those skilled in the art will appreciate that embodiments of the present disclosure may be provided as a method, system, or computer program product. Accordingly, the present disclosure may take the form of an entire hardware embodiment, an entire software embodiment, or a combination of software and hardware embodiment. In addition, the present disclosure may take the form of a computer program product executing on one or more computer-readable storage media (including but not limited to disk storage, CD-ROM, optical storage, etc.) including computer executable program code.

The present disclosure has been described with reference to the flowcharts and/or block diagrams of methods, apparatuses (systems), and computer program products according to the embodiments of the present disclosure. It is to be understood that each individual flow of the flowcharts and/or block of the block diagrams, or a combination thereof, may be implemented by computer program instructions. These computer program instructions may be provided to a processor of a general purpose computer, specialized computer, embedded processor, or other programmable data processing device to produce a machine, which allows a production of an apparatus for implementing the functions specified by one or more flows of the flowcharts and/or one or more blocks of the block diagrams through executing the instructions by a processor of a computer or another programmable data processing device.

These computer program instructions may also be stored in a computer-readable memory that can direct a computer or another programmable data processing device to function in a specified manner, which allows a product, containing an instruction apparatus, to be produced by the instructions stored in the computer-readable memory. The instruction apparatus implements the functions specified in one or more flows of the flowcharts and/or one or more blocks of the block diagrams.

These computer program instructions may also be loaded onto a computer or another programmable data processing device, to allow a series of operational steps to be implemented on the computer or another programmable data processing device to produce a computer implemented process. Accordingly, the instructions implemented on the computer or another programmable data processing device provide processes for achieving the functions specified in one or more flows of the flowcharts and/or one or more blocks of the block diagrams.

Although preferred embodiments of the present disclosure have been described, these embodiments may be altered or modified by a person skilled in the art once the essential and creative concepts are recognized. Accordingly, the appended claims are intended to be interpreted as covering the preferred embodiments and any modifications and variations that fall within the scope of the present disclosure.

Clearly, a person skilled in the art may make various modifications and variations to the present disclosure without departing from the spirit and scope of the present disclosure. Accordingly, if these medications and variations of the present disclosure fall with the scope of the claims of the present disclosure or the equivalent technologies, the present disclosure intends to cover these modifications and variations.

1. A method for implementing a server anti-attack, comprising:
receiving, by a server, a first link request, wherein the first link request includes a source IP address that initiates the first link request;
determining, by the server, a target request type of the first link request based on feature information of the first link request, wherein the feature information of the first link request includes at least one of request data, a requesting rule, and requested content;
determining, by the server, the number of requests that are initiated by the source IP address within a first preset period and have a request type consistent with the target request type based on the target request type of the first link request; and
if it is determined that the number of requests, that are initiated by the source IP address and have a request type consistent with the target request type, is greater than a preset threshold, determining, by the server, a target attack type of the first link request based on the target request type, rejecting the first link request, and adding the source IP address to a first collection, wherein the first collection is configured to store IP addresses that the server denies access.

2. The method according to claim 1, wherein:
determining, by the server, the target request type of the first link request based on the feature information of the first link request further includes:
if it is determined, based on the request data of the first link request, that the request data cannot be assembled into a request format that can be recognized by the server, determining, by the server, that the target request type of the first link request is an SYN flood request;
determining, by the server, the number of requests that are initiated by the source IP address within the first preset period and have a request type consistent with the target request type further includes:
determining, by the server, the number of requests that are initiated by the source IP address within the first preset period and have a request type of an SYN flood request; and
if it is determined that the number of requests, that are initiated by the source IP address and have a request type consistent with the target request type, is greater than the preset threshold, determining, by the server, the target attack type of the first link request based on the target request type further includes:
if it is determined that the number of SYN flood requests initiated by the source IP address is greater than a first preset threshold, determining, by the server, that the target attack type of the first link request is an SYN flood attack.

3. The method according to claim 1, wherein:
determining, by the server, the target request type of the first link request based on the feature information of the first link request further includes:
if it is determined, based on the request data and the requesting rule of the first link request, that the request data can be assembled into a request format that can be recognized by the server but the requesting rule does not satisfy a preset rule, determining, by the server, that the target request type of the first link request is an illegal URL request;
determining, by the server, the number of requests that are initiated by the source IP address within the first preset period and have a request type consistent with the target request type further includes:
determining, by the server, the number of requests that are initiated by the source IP address within the first preset period and have a request type of an illegal URL request; and
if it is determined that the number of requests, that are initiated by the source IP address and have a request type consistent with the target request type, is greater than the preset threshold, determining, by the server, the target attack type of the first link request based on the target request type further includes:
if it is determined that the number of illegal URL requests initiated by the source IP address is greater than a second preset threshold, determining, by the server, that the target attack type of the first link request is an illegal URL attack.

4. The method according to claim 1, wherein determining, by the server, the target request type of the first link request based on the feature information of the first link request further includes:
if it is determined, based on the request data and the requesting rule of the first link request, that the request data can be assembled into a request format that can be recognized by the server and the requesting rule satisfies a preset rule, determining, by the server, that the target request type of the first link request is a candidate legal URL request, and
if it is determined, based on the requested content of the first link request, that the requested content is inconsistent with content of services provided by the server, determining, by the server, that the candidate legal URL request is a first type of legal URL request;
determining, by the server, the number of requests that are initiated by the source IP address within the first preset period and have a request type consistent with the target request type further includes:
determining, by the server, the number of requests that are initiated by the source IP address within the first preset period and have a request type of a first type of legal URL request; and
if it is determined that the number of requests, that are initiated by the source IP address and have a request type consistent with the target request type, is greater than the preset threshold, determining, by the server, the target attack type of the first link request based on the target request type further includes:
if it is determined that the number of first type of legal URL requests is greater than a third preset threshold, determining, by the server, that the target attack type of the first link request is a legal URL attack.

5. The method according to claim 4, further comprising:
if it is determined that the requested content is consistent with the content of services provided by the server, determining, by the server, that the candidate legal URL request is a second type of legal URL request;
if it is determined that the source IP address is included in a second collection, determining, by the server, the number of second type of legal URL requests initiated by the source IP address within a second preset period, wherein the second collection is configured to store IP addresses restricted by the server and corresponding numbers of requests received after restrictions; and
if it is determined that the number of second type of legal URL requests initiated by the source IP address within the second preset period is greater than the number of requests received after a restriction, determining, by the server, that the target attack type of the first link request is a legal URL attack, rejecting the first link request, and adding the source IP address to the first collection.

6. The method according to claim 5, further comprising:
if it is determined that the number of second type of legal URL requests initiated by the source IP address within the second preset period is less than or equal to the number of requests received after the restriction, determining, by the server, that the first link request is a legal request.

7. The method according to claim 5, further comprising:
if it is determined that the source IP address is not included in the second collection, determining, by the server, the number of second type of legal URL requests initiated by the source IP address within a third preset period;
if it is determined that the number of second type of legal URL requests initiated by the source IP address within the third preset period is greater than a fourth preset threshold, restricting, by the server, the number of requests from the source IP address and adding the source IP address to the second collection, wherein the third preset period is earlier than the second preset period; and
if it is determined that the number of second type of legal URL requests initiated by the source IP address within the third preset period is less than or equal to the fourth preset threshold, determining, by the server, that the first link request is a legal request.

8. The method according to claim 1, wherein, after receiving the first link request and before determining the target request type of the first link request, the method further includes:
determining, by the server, that the source IP address is not included in the first collection.

9. An apparatus for implementing a server anti-attack, comprising:
a receiving unit that is configured to receive a first link request, wherein the first link request includes a source IP address that initiates the first link request; and
a processing unit that is configured to:
determine a target request type of the first link request based on feature information of the first link request, wherein the feature information of the first link request includes at least one of request data, a requesting rule, and requested content,
determine the number of requests that are initiated by the source IP address within a first preset period and have a request type consistent with the target request type based on the target request type of the first link request, and
if it is determined that the number of requests, that are initiated by the source IP address and have a request type consistent with the target request type, is greater than a preset threshold, determine a target attack type of the first link request based on the target request type, reject the first link request, and add the source IP address to a first collection, wherein the first collection is configured to store IP addresses that the server denies access.

10. The apparatus according to claim 9, wherein the processing unit is further configured to:
if it is determined, based on the request data of the first link request, that the request data cannot be assembled into a request format that can be recognized by the server, determine that the target request type of the first link request is an SYN flood request;
determine the number of requests that are initiated by the source IP address within the first preset period and have a request type of an SYN flood request; and
if it is determined that the number of SYN flood requests initiated by the source IP address is greater than a first preset threshold, determine that the target attack type of the first link request is an SYN flood attack.

11. The apparatus according to claim 9, wherein the processing unit is further configured to:
if it is determined, based on the request data and the requesting rule of the first link request, that the request data can be assembled into a request format that can be recognized by the server but the requesting rule does not satisfy a preset rule, determine that the target request type of the first link request is an illegal URL request;
determine the number of requests that are initiated by the source IP address within the first preset period and have a request type of an illegal URL request; and
if it is determined that the number of illegal URL requests initiated by the source IP address is greater than a second preset threshold, determine that the target attack type of the first link request is an illegal URL attack.

12. The apparatus according to claim 9, wherein the processing unit is further configured to:
if it is determined, based on the request data and the requesting rule of the first link request, that the request data can be assembled into a request format that can be recognized by the server and the requesting rule satisfies a preset rule, determine that the target request type of the first link request is a candidate legal URL request;
if it is determined, based on the requested content of the first link request, that the requested content is inconsistent with content of services provided by the server, determine that the candidate legal URL request is a first type of legal URL request;
determine the number of requests that are initiated by the source IP address within the first preset period and that have a request type of a first type of legal URL request; and
if it is determined that the number of first type of legal URL requests initiated by the source address is greater than a third preset threshold, determine that the target attack type of the first link request is a legal URL attack.

13. The apparatus according to claim 12, wherein the processing unit is further configured to:
if it is determined that the requested content is consistent with the content of services provided by the server, determine that the candidate legal URL request is a second type of legal URL request;
if it is determined that the source IP address is included in a second collection, determine the number of second type of legal URL requests initiated by the source IP address within a second preset period, wherein the second collection is to store IP addresses restricted by the server and corresponding numbers of requests after restrictions; and
if it is determined that the number of second type of legal URL requests initiated by the source IP address within the second preset period is greater than the number of requests received after a restriction, determine that the target attack type of the first link request is a legal URL attack, reject the first link request, and add the source IP address to the first collection.

14. The apparatus according to claim 13, wherein the processing unit is further configured to:
if it is determined that the number of second type of legal URL requests initiated by the source IP address within the second preset period is less than or equal to the number of requests received after the restriction, determine that the first link request is a legal request.

15. The apparatus according to claim 13, wherein the processing unit is further configured to:
if it is determined that the source IP address is not included in the second collection, determine the number of second type of legal URL requests initiated by the source IP address within a third preset period;
if it is determined that the number of second type of legal URL requests initiated by the source IP address within the third preset period is greater than a fourth preset threshold, restrict the number of requests from the source IP address and add the source IP address to the second collection, wherein the third preset period is earlier than the second preset period; and
if it is determined that the number of second type of legal URL requests initiated by the source IP address within the third preset period is less than or equal to the fourth preset threshold, determine that the first link request is a legal request.

16. The apparatus according to claim 9, wherein, after receiving the first link request and before determining the target request type of the first link request, the processing unit is further configured to:
determine that the source IP address is not included in the first collection.

17. (canceled)

18. A computer device, comprising:
a memory configured to store program instructions; and
a processor configured to call the program instructions stored in the memory, and implement, based on an obtained program, a method for implementing a server anti-attack that includes:
receiving, by a server, a first link request, wherein the first link request includes a source IP address that initiates the first link request;
determining, by the server, a target request type of the first link request based on feature information of the first link request, wherein the feature information of the first link request includes at least one of request data, a requesting rule, and requested content;
determining, by the server, the number of requests that are initiated by the source IP address within a first preset period and have a request type consistent with the target request type based on the target request type of the first link request; and
if it is determined that the number of requests, that are initiated by the source IP address and have a request type consistent with the target request type, is greater than a preset threshold, determining, by the server, a target attack type of the first link request based on the target request type, rejecting the first link request, and adding the source IP address to a first collection, wherein the first collection is configured to store IP addresses that the server denies access.
